(19) United States
(12) Patent Application Publication
(10) Pub. No.: US 2020/0114405 A1
(43) Pub. Date: Apr. 16, 2020

(54) Method For Thermal Desorption Treatment Of Organic-Contaminated Soil

(71) Applicant: Kunming University of Science and Technology, Kunming (CN)

(72) Inventors: Senlin TIAN, Kunming (CN); Qun ZHAO, Kunming (CN); Yingjie LI, Kunming (CN); Jianhong HUANG, Kunming (CN); Xuewei HU, Kunming (CN); Xiaolong CHAI, Kunming (CN); Yan CAO, Kunming (CN); Yingxue GENG, Kunming (CN); Linzhen XU, Kunming (CN); Linfeng ZHANG, Kunming (CN); Yina TU, Kunming (CN)

(73) Assignee: Kunming University of Science and Technology, Kunming (CN)

(21) Appl. No.: 16/594,229

(22) Filed: Oct. 7, 2019

(30) Foreign Application Priority Data
Oct. 15, 2018 (CN) 201811193619.3

(51) Int. Cl. B09C 1/06

(52) U.S. Cl. CPC B09C 1/065

(57) ABSTRACT

The present disclosure relates to a method for thermal desorption treatment of organic-contaminated soil. The method includes: subjecting thermal desorption flue gas with a temperature of 120-700° C. and the organic-contaminated soil to a countercurrent contact reaction for 5-30 min to obtain desorption waste gas comprising an organic pollutant and thermally desorbed soil; drying biomass to a water content of ≤12%, and crushing to a length of ≤20 cm to obtain a biomass segment; uniformly mixing the thermally desorbed soil with the biomass segment to obtain a mixture A, carrying out low-temperature pyrolytic carbonization of the biomass in the mixture A at a temperature of 250-450° C., heating the soil to obtain remedied soil including organic carbon and pyrolysis gas from the low-temperature pyrolytic carbonization. The disclosure mixes the thermally desorbed soil with the biomass for pyrolytic carbonization, greatly improving the content of an organic matter, recovering a soil function.

### CROSS-REFERENCE TO RELATED APPLICATIONS

This application claims priority to Chinese application number 2018111936193, filed Oct. 15, 2018, with a title of METHOD FOR THERMAL DESORPTION TREATMENT OF ORGANIC-CONTAMINATED SOIL. The above-mentioned patent application is incorporated herein by reference in its entirety.

### FIELD

The present disclosure relates to a method for thermal desorption treatment of organic-contaminated soil, and belongs to the technical field of regeneration of contaminated soil.

### BACKGROUND

The problem of soil contamination in China is prominent, and the demand for a remediation technology is urgent. Contaminated soil can be divided into organic-contaminated soil and inorganic-contaminated soil. According to the nature of organic pollutants and different technical principles, remediation technologies of the organic-contaminated soil mainly include thermal desorption, steam extraction, chemical oxidation/reduction, a fixation/stabilization method, an incineration method, a microbial method, a phytoremediation method, and the like. The thermal desorption technology is one of the effective methods for remediation of the organic-contaminated soil. Different heat sources are used to heat the organic-contaminated soil to near or above a boiling point of an organic compound, so that the organic pollutant is volatilized and separated from the soil, and then desorption waste gas is treated to achieve the goal of remediation. The thermal desorption method can effectively remove volatile and semi-volatile organic pollutants in the soil, such as volatile organic compounds (VOCs), polycyclic aromatic hydrocarbons (PAHs), and polychlorinated biphenyls (PCBs).

However, the current research on the thermal desorption of the organic-contaminated soil only involves the removal of an organic pollutant, and most of the soil obtained after remediation has poor soil quality, a decreased organic matter, significantly reduced soil fertility, and even loss of a soil function, making it difficult to grow crops.

In the prior art, an environmentally-friendly thermal desorption remediation system for the organic-contaminated soil utilizes waste heat of high-temperature soil after thermal desorption treatment to pyrolyze biomass of agricultural and forestry waste, but this method only utilizes the waste heat, and does not solve the problem of poor soil quality and a low organic matter.

### SUMMARY

In view In view of problems that most of soil obtained after the removal of an organic pollutant from organic-contaminated soil has poor soil quality, a low organic matter, low effective utilization rate of agricultural and forestry solid waste, and serious incineration pollution, etc., the present disclosure provides a method for thermal desorption treatment of organic-contaminated soil, which simultaneously realizes the disposal and utilization of organic solid waste such as crop straw, thermal desorption remediation of soil, and recovery of a soil function, increases the content of organic carbon in soil, improves soil fertility, and kills a harmful pathogenic microorganism in soil and biomass.

A method for thermal desorption treatment of organic-contaminated soil, including the following specific steps:

(1) subjecting thermal desorption flue gas with a temperature of 120-700° C. and the organic-contaminated soil to a countercurrent contact reaction for 5-60 min to obtain desorption waste gas including an organic pollutant and thermally desorbed soil;

(2) drying biomass to a water content of ≤12%, and crushing to a length of ≤20 cm to obtain a biomass segment, where the biomass is one or more of crop straw, a weed, a rice husk, a chaff, a shrub branch, a dead tree leaf and sawdust; and

(3) uniformly mixing the thermally desorbed soil of the step (1) with the biomass segment of the step (2) to obtain a mixture A, carrying out low-temperature pyrolytic carbonization of the biomass in the mixture A at a temperature of 250-450° C., and heating the soil to obtain remedied soil including organic carbon and pyrolysis gas from the low-temperature pyrolytic carbonization;

where in the step (1), the thermal desorption waste gas is high-temperature gas of a burner and/or the pyrolysis gas from the low-temperature pyrolytic carbonization in the step (3);

in the step (3), a mass ratio of the thermally desorbed soil in the mixture A to the biomass segment is 1:(2-9).

The beneficial effects of the present disclosure are:

(1) the present disclosure carries out the low-temperature pyrolytic carbonization of the biomass, by which a chemical bond in a macromolecule of the biomass is cut by thermal energy to convert the macromolecule of the biomass into a low-molecule substance to obtain a carbon-rich product under the condition of isolating air or introducing a small amount of air; different from a high-temperature carbonizing technology, when agricultural and forestry waste is carbonized at a relatively low temperature, a pore structure of a biomass raw material will be well preserved, increasing a soil organic matter, and fixing carbon and reducing discharge;

(2) the present disclosure simultaneously realizes the disposal and utilization of organic solid waste such as crop straw, and thermal desorption remediation of soil and recovery of a soil function; the organic-contaminated soil is first thermally desorbed, and then directly mixed with the biomass for pyrolysis after thermal desorption, which effectively removes an organic pollutant and recovers a soil function;

(3) the present disclosure mixes the thermally desorbed soil with the biomass for pyrolytic carbonization, greatly improving the content of an organic matter, recovering a soil function, and avoiding a problem of conventional thermal desorption remediation that a soil function is lost due to the burning destruction of an organic matter;

(4) the method of the present disclosure generates a high temperature in the low-temperature pyrolysis process, which can effectively kill a harmful pathogenic microorganism in soil and biomass;

(5) the present disclosure can remedy a soil structure after increasing the organic carbon content and effectively killing the harmful pathogenic microorganism; and

(6) the present disclosure returns the pyrolysis gas generated during the mixed pyrolysis process of the biomass and the soil to recycle it as thermal desorption flue gas for assisting the high-temperature thermal desorption of the soil, and the soil after the high-temperature thermal desorption treatment is directly mixed with the biomass to provide part of heat by its waste heat to realize the thermal energy recycling of the entire system, thereby greatly reducing the energy consumption of the entire soil treatment process.

### BRIEF DESCRIPTION OF THE DRAWINGS

FIG. 1 is a flowchart of a process according to the present disclosure.

### DETAILED DESCRIPTION

The present disclosure will be further described below with reference to specific implementations.

### Example 1: Organic-Contaminated Soil from a Chemical Engineering Site

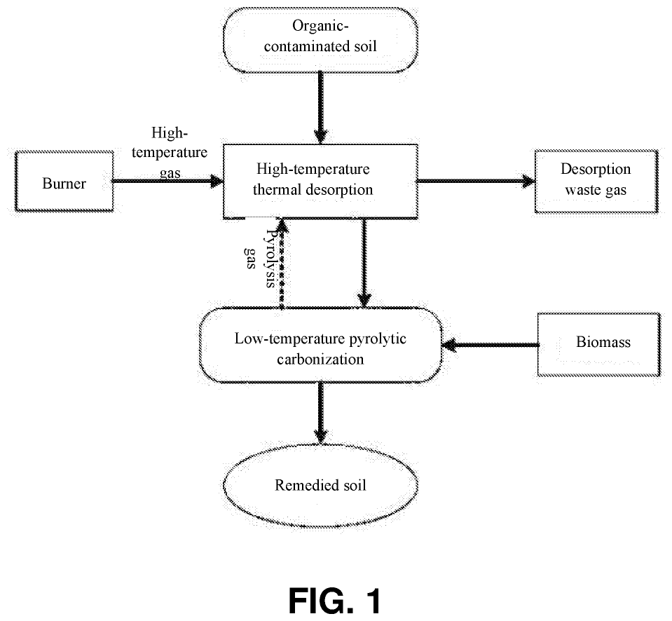

As shown in FIG. 1, a method for thermal desorption treatment of organic-contaminated soil includes the following specific steps:

(1) subject thermal desorption flue gas (high-temperature gas of a burner) with a temperature 500° C. and the organic-contaminated soil to a countercurrent contact reaction for 15 min to obtain desorption waste gas including an organic pollutant and thermally desorbed soil;

(2) dry biomass (crop straw) to a water content of ≤12%, and crush to a length of ≤20 cm to obtain a biomass segment; and

(3) uniformly mix the thermally desorbed soil of the step (1) with the biomass segment of the step (2) to obtain a mixture A, carry out low-temperature pyrolytic carbonization of the biomass in the mixture A at a temperature of 250° C., and heat the soil to obtain remedied soil including organic carbon and pyrolysis gas from the low-temperature pyrolytic carbonization, where a mass ratio of the thermally desorbed soil in the mixture A to the biomass segment is 1:2.

After the treatment of the present embodiment, the organic matter removal rate of the soil reaches 98.33%. The results of a planting experiment indicates that under the condition of consistent cultivation and fertilization, the yield of rapeseed planted in the soil before treatment was 200 kg/mu, and the yield of rapeseed planted in the soil after treatment was 580 kg/mu.

### Example 2: Organic-Contaminated Soil from a Chemical Engineering Site

As shown in FIG. 1, a method for thermal desorption treatment of organic-contaminated soil includes the following specific steps:

(1) subject thermal desorption flue gas (the pyrolysis gas from the low-temperature pyrolytic carbonization in the step (3)) with a temperature 400° C. and the organic-contaminated soil to a countercurrent contact reaction for 20 min to obtain desorption waste gas including an organic pollutant and thermally desorbed soil;

(2) dry biomass (a mixture of crop straw, a weed, a rice husk, a chaff, a shrub branch, a dead tree leaf and sawdust) to a water content of ≤10%, and crush to a length of ≤18 cm to obtain a biomass segment; and

(3) uniformly mix the thermally desorbed soil of the step (1) with the biomass segment of the step (2) to obtain a mixture A, carry out low-temperature pyrolytic carbonization of the biomass in the mixture A at a temperature of 300° C., heat the soil to obtain remedied soil including organic carbon and pyrolysis gas from the low-temperature pyrolytic carbonization, and return the pyrolysis gas from the low-temperature pyrolytic carbonization to the step (1) for a countercurrent contact reaction with the organic-contaminated soil, where a mass ratio of the thermally desorbed soil in the mixture A to the biomass segment is 1:4.

After the treatment of the present embodiment, the organic matter removal rate of the soil reaches 97.58%. The results of a planting experiment indicates that under the condition of consistent cultivation and fertilization, the yield of dry rice planted in the soil before treatment was 178 kg/mu, and the yield of dry rice planted in the soil after treatment was 310 kg/mu.

### Example 3: Organic-Contaminated Soil from a Chemical Engineering Site

As shown in FIG. 1, a method for thermal desorption treatment of organic-contaminated soil includes the following specific steps:

(1) subject thermal desorption flue gas (high-temperature gas of a burner) with a temperature 700° C. and the organic-contaminated soil to a countercurrent contact reaction for 5 min to obtain desorption waste gas including an organic pollutant and thermally desorbed soil;

(2) dry biomass (a mixture of crop straw, a weed and a rice husk) to a water content of 9%, and crush to a length of 15 cm to obtain a biomass segment; and

(3) uniformly mix the thermally desorbed soil of the step (1) with the biomass segment of the step (2) to obtain a mixture A, carry out low-temperature pyrolytic carbonization of the biomass in the mixture A at a temperature of 400° C., heat the soil to obtain remedied soil including organic carbon and pyrolysis gas from the low-temperature pyrolytic carbonization, and return the pyrolysis gas from the low-temperature pyrolytic carbonization to the step (1) for a countercurrent contact reaction with the organic-contaminated soil, where a mass ratio of the thermally desorbed soil in the mixture A to the biomass segment is 1:7.

After the treatment of the present embodiment, the organic matter removal rate of the soil reaches 98.62%. The results of a planting experiment indicates that under the condition of consistent cultivation and fertilization, the yield of rapeseed planted in the soil before treatment was 220 kg/mu, and the yield of rapeseed planted in the soil after treatment was 545 kg/mu.

### Example 4: Organic-Contaminated Soil from a Chemical Engineering Site

As shown in FIG. 1, a method for thermal desorption treatment of organic-contaminated soil includes the following specific steps:

(1) subject thermal desorption flue gas (mixed gas of high-temperature gas of a burner and the pyrolysis gas from the low-temperature pyrolytic carbonization the step (3)) with a temperature 500° C. and the organic-contaminated soil to a countercurrent contact reaction for 25 min to obtain desorption waste gas including an organic pollutant and thermally desorbed soil;

(2) dry biomass (a mixture of a weed, a rice husk, a chaff, a shrub branch, a dead tree leaf and sawdust) to a water content of ≤11%, and crush to a length of ≤12 cm to obtain a biomass segment; and

(3) uniformly mix the thermally desorbed soil of the step (1) with the biomass segment of the step (2) to obtain a mixture A, carry out low-temperature pyrolytic carbonization of the biomass in the mixture A at a temperature of 450° C., heat the soil to obtain remedied soil including organic carbon and pyrolysis gas from the low-temperature pyrolytic carbonization, and return the pyrolysis gas from the low-temperature pyrolytic carbonization to the step (1) for a countercurrent contact reaction with the organic-contaminated soil, where a mass ratio of the thermally desorbed soil in the mixture A to the biomass segment is 1:9.

After the treatment of the present embodiment, the organic matter removal rate of the soil reaches 97.69%. The results of a planting experiment indicates that under the condition of consistent cultivation and fertilization, the yield of dry rice planted in the soil before treatment was 202 kg/mu, and the yield of dry rice planted in the soil after treatment was 345 kg/mu.

### Example 5: Organic-Contaminated Soil from a Chemical Engineering Site

As shown in FIG. 1, a method for thermal desorption treatment of organic-contaminated soil includes the following specific steps:

(1) subject thermal desorption flue gas (mixed gas of the pyrolysis gas from the low-temperature pyrolytic carbonization the step (3)) with a temperature 120° C. and the organic-contaminated soil to a countercurrent contact reaction for 30 min to obtain desorption waste gas including an organic pollutant and thermally desorbed soil;

(2) dry biomass (a mixture of a rice husk, a shrub branch, a dead tree leaf and sawdust) to a water content of 10%, and crush to a length of 16 cm to obtain a biomass segment; and

(3) uniformly mix the thermally desorbed soil of the step (1) with the biomass segment of the step (2) to obtain a mixture A, carry out low-temperature pyrolytic carbonization of the biomass in the mixture A at a temperature of 350° C., heat the soil to obtain remedied soil including organic carbon and pyrolysis gas from the low-temperature pyrolytic carbonization, and return the pyrolysis gas from the low-temperature pyrolytic carbonization to the step (1) for a countercurrent contact reaction with the organic-contaminated soil, where a mass ratio of the thermally desorbed soil in the mixture A to the biomass segment is 1:5.

After the treatment of the present embodiment, the organic matter removal rate of the soil reaches 98.62%. The results of a planting experiment indicates that under the condition of consistent cultivation and fertilization, the yield of rapeseed planted in the soil before treatment was 230 kg/mu, and the yield of rapeseed planted in the soil after treatment was 562 kg/mu.

The specific implementations of the present disclosure are described in detail above, but the present disclosure is not limited to the above implementations. Within the knowledge of a person of ordinary skill in the art, various variations can also be made without departing from the spirit of the present disclosure.

What is claimed is:

1. A method for thermal desorption treatment of organic-contaminated soil, comprising the following specific steps:
(1) subjecting thermal desorption flue gas with a temperature of 120-700° C. and the organic-contaminated soil to a countercurrent contact reaction for 5-60 min to obtain desorption waste gas comprising an organic pollutant and thermally desorbed soil;
(2) drying biomass to a water content of ≤12%, and crushing to a length of ≤20 cm to obtain a biomass segment, wherein the biomass is one or more of crop straw, a weed, a rice husk, a chaff, a shrub branch, a dead tree leaf and sawdust; and
(3) uniformly mixing the thermally desorbed soil of the step (1) with the biomass segment of the step (2) to obtain a mixture A, carrying out low-temperature pyrolytic carbonization of the biomass in the mixture A at a temperature of 250-450° C., and heating the soil to obtain remedied soil comprising organic carbon and pyrolysis gas from the low-temperature pyrolytic carbonization.

2. The method for thermal desorption treatment of organic-contaminated soil according to claim 1, wherein in the step (1), the thermal desorption waste gas is high-temperature gas of a burner and/or the pyrolysis gas from the low-temperature pyrolytic carbonization in the step (3).

3. The method for thermal desorption treatment of organic-contaminated soil according to claim 1, wherein in the step (3), a mass ratio of the thermally desorbed soil in the mixture A to the biomass segment is 1:(2-9).
